(19) United States
(12) Patent Application Publication
(10) Pub. No.: US 2010/0012227 A1
(43) Pub. Date: Jan. 21, 2010

(54) Lumber processing system

(76) Inventors: Greg Zielke, Centerview, MO (US); John Moody, Morgantown, WV (US)

Correspondence Address: Edward A. McConwell, Jr., 5925 Beverly, Mission, KS, 66202, US

(21) Appl. No.: 12/383,903

(22) Filed: Mar. 30, 2009

Related U.S. Application Data
(62) Division of application No. 11/181,073, filed on Jul. 14, 2005.

(51) Int. Cl. B23Q 15/00

(52) U.S. Cl. 144/392; 700/166; 700/167

(57) ABSTRACT

A lumber processing system for cutting lumber into predetermined shapes broadly includes a scanning section, a computer section and a cutting section. Incoming lumber is scanned in the scanning section using two-color cameras capturing images first under normal lighting and second under ultraviolet (black) lighting for illumination of pre-marked defects. Images are processed in the computer section to produce a polygonal model of the lumber. A series of auxiliary packing computers review the model and determine separate solutions for cutting the lumber. Parts are then ‘punched’ from the lumber in the cutting section utilizing high power lasers cutting from both sides of the lumber simultaneously.

This is a divisional application of application Ser. No. 11/181,073 filed Jul. 14, 2005.

### BACKGROUND OF THE INVENTION

1. Field of the Invention

The present invention relates generally to a system for analyzing lumber and determining a preferred path for cutting the lumber. More particularly, the present invention relates to a system for cutting blanks from a piece of lumber where the lumber is analyzed and the blanks to be cut from the lumber are arranged to maximize the value of the cut parts from the lumber and minimize waste.

2. Discussion of the Prior Art

Throughout history, the woodworking industry has continually strived to reduce the amount of waste in order to maximize profits and for environmental concerns, such as excessive deforestation and disposal of scrap lumber. Maximizing the utilization of lumber has met with numerous challenges in an increasingly industrialized world. For example, each piece of lumber is unique having its own shape, density, color, and defects. In the more industrialized sectors of the woodworking industry where mass production is required, many thousands of identical pieces or blanks are needed to be cut from these uniquely individual pieces of lumber. As a result, the placement of the blanks to be cut from each piece of lumber is time consuming and often results in great waste.

Several systems have been developed in order to maximize the utilization of lumber and minimize waste. For example, U.S. Pat. No. 4,221,974 to Mueller et al. (the Mueller patent) discloses a system for inspecting lumber and optimizing the utilization of the lumber. U.S. Pat. No. 3,120,861 to Finlay et al. (the Finlay patent) discloses a system that incorporates an electro-optical device for scanning a piece of lumber for flaws. U.S. Pat. No. 3,329,181 to Buss et al. (the Buss patent) discloses another electro-optical device for scanning a piece of lumber and for providing input to software used in nesting or optimization. While each of these references represent some form of an advance in the state of the art of mass-production wood cutting and processing, they still result in relatively high percentages of waste, and thus lower the value of the cut parts than could be otherwise obtained.

### BRIEF SUMMARY OF THE INVENTION

A lumber processing system constructed in accordance with the present invention accepts incoming marked lumber and produces cut parts of any of various, desired, predetermined shapes. The system broadly includes a scanning section, a computer section and a cutting section. Incoming lumber is scanned in the scanning section using two color cameras capturing images of both sides of the lumber first under normal lighting and second under ultraviolet (black) lighting for illumination of pre-marked defects. Images are processed in the computer section to produce a polygonal model of each section. These section models are then merged to produce a complete polygonal model of the entire scanned piece of lumber. A series of auxiliary packing computers review the complete model and each determine separate solutions for cutting the lumber to create the predetermined shapes. Parts are then ‘punched’ from the lumber in the cutting section utilizing high power lasers cutting from both sides of the lumber simultaneously. It should be noted that these parts, or blanks, are later worked to create a finished product, such as a gun stock.

The system includes a plurality of computers performing three classes of functions. A first class includes a main computer that provides a user interface for controlling the system and for inputting data representative of the desired shapes that will be cut from the lumber. A second class includes a machine control computer that provides control of the cutting section. A third class has a plurality of packing computers that calculate potential packing solutions during the available time between scanning and cutting of the lumber, or as defined by the user.

The main computer performs several functions. The main computer coordinates overall system operation, provides the user interface, receives continuous system status updates and updates the user interface as appropriate, creates logs of system operation, generates a desired cutting path based on polygonal packing solutions, transmits the desired cutting path to Machine Control computer, and receives video images from the scanning system to create a complete polygonal model of the piece of lumber being cut.

The machine control computer continuously scans for inputs and generates appropriate outputs, provides manual control of the cutting section while in a manual mode, coordinates the cutting section operation when in automatic mode, reports cutting section status to the main computer, and receives the desired cutting path from main computer. In addition, the machine control computer provides manual and automatic control of the scanning section.

The auxiliary packing computers each receive a unique algorithm from the main computer. The packing computers also receive a cutting bill and the polygonal model of the lumber from the main computer. Each of the packing computers then independently and repeatedly generate packing solutions based on the cutting bill and the polygonal model, retaining the highest scoring solution in accordance with their unique system parameters. Once a predetermined time has elapsed, the lumber is moved to the cutting section and into position for cutting and then each packing computer transmits its highest scoring solution to the main computer.

Once the main computer receives the packing computer solutions, the main computer selects the highest scoring solution from the packing computer solutions as the cutting solution. The associated cutting path is then transmitted to the machine control computer. Once the cutting path is received by the machine control computer and the piece of lumber is in position for cutting, the cutting section will cut the lumber in accordance with the cutting path.

The lumber is cut using high powered lasers positioned on each side of the lumber. The lasers cut the lumber simultaneously and are powered so that the lumber is cut completely through from side to side without damaging each other. The laser cuts are relatively precise so that the blanks cut by the lasers do not fall from the piece of lumber, but are easily removed once the cut lumber is moved out of the system.

### BRIEF DESCRIPTION OF THE SEVERAL VIEWS OF THE DRAWINGS

A preferred embodiment of a lumber processing system is described in detail below with reference to the drawing figures, wherein:

FIG. 1 is a schematic drawing of a lumber processing system constructed in accordance with a preferred embodiment of the present invention;

FIG. 2 is a block diagram of the computer section of the system;

FIG. 3 is a flow chart diagram of the main computer ALPSX program;

FIG. 4 is a flow chart diagram of the hardware initialization;

FIG. 5 is a flow chart diagram of the LOG message processing;

FIG. 6 is a flow chart diagram of inter-computer communications within the computer section;

FIG. 7 is a flow chart diagram of the overview of the image acquisition and processing thread of the system;

FIG. 8 is a flow chart diagram of the image acquisition of lumber in the scanning section;

FIG. 9 is a flow chart diagram of the processing of scanning data collected by the scanning section;

FIG. 10 is a flow chart diagram of the overview of the packing solution process performed by the computer section of the system;

FIG. 11 is a flow chart diagram of the packing solution process of the system;

FIG. 12 is a flow chart diagram of the cutting path solution process;

FIG. 13 is a flow chart diagram of the initialization process of the system;

FIG. 14 is a flow chart diagram of the hardware initialization process of the system;

FIG. 15 is a flow chart diagram of the system sequencing thread;

FIG. 16 is a flow chart diagram of the system control loop;

FIG. 17 is a flow chart diagram of the auxiliary packing computer initialization;

FIG. 18 is a flow chart diagram of the packing thread;

FIG. 19 is a flow chart diagram of the cutting solution selection performed by the main computer; and

FIG. 20 is a flow chart diagram of the operation of the lumber processing system.

### DETAILED DESCRIPTION OF THE PREFERRED EMBODIMENT

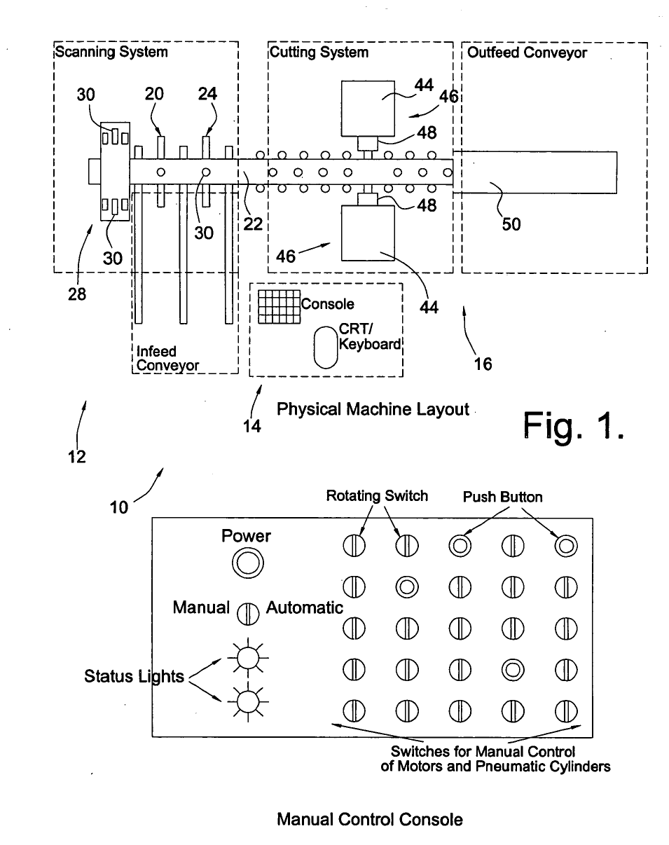

Referring now to the drawings, FIG. 1 depicts a preferred embodiment of a lumber processing system 10. The system 10 broadly includes a scanning section 12, a computer section 14, and a cutting and output section 16. Generally, the pieces of lumber configured for use in the system 10 are elongated and present a pair of opposed faces with a rectangular cross-sectional shape. For example, the piece of may have a 2″×10″ cross-sectional dimension. Of course, the system 10 may also accommodate lumber of various other dimensions.

The scanning section 12 includes an infeed conveyor 18 for receiving a piece of lumber. The infeed conveyor 18 transfers the lumber to a rotation station 20 along a central conveyor 22. The rotation station 20 uses a plurality of swing bars 24 to rotate the lumber from a flat, horizontal configuration to a vertical configuration where the faces of the lumber are generally vertical. A plurality of clamping pins 26 is provided to firmly support the lumber in the vertical configuration. Each of the pins 26 contacts a side of the lumber once the swing bars 24 rotate the lumber to the vertical position, clamping the lumber to the central conveyor 22.

A camera array carriage 28 includes a pair of opposed cameras 30 for taking images of the faces of the lumber under white light and ultraviolet, or black, light. Once the lumber has been positioned vertically on the central conveyor 22, the carriage 28 moves along the lumber in a first direction wherein the cameras 30 take images of the lumber alternating between white and black light, and then the carriage reverses course and moves along the lumber in a second direction until the carriage 28 has returned to its start position. The images are transferred to the computer section 14 for analysis.

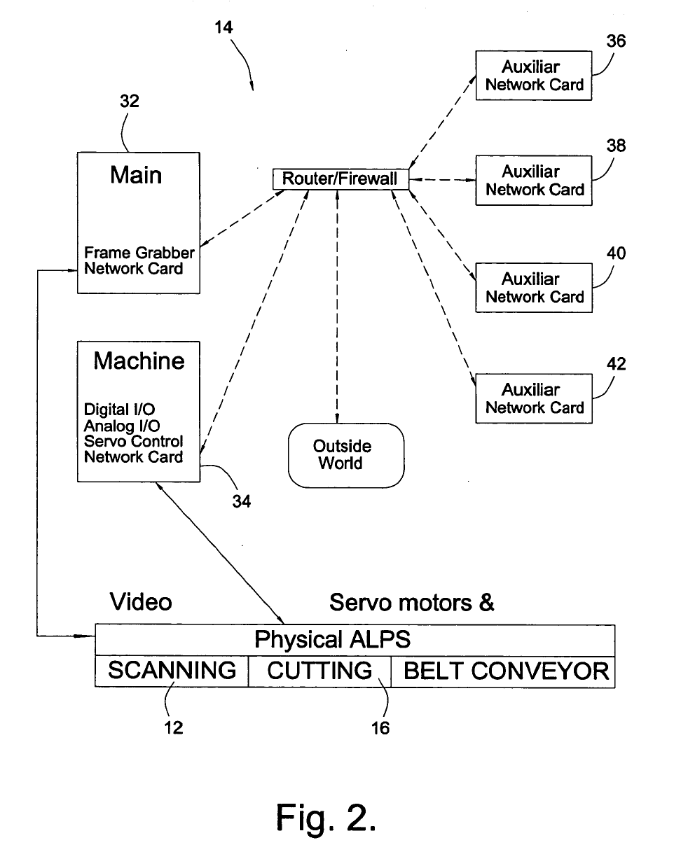

Turning now to FIG. 2, the computer section 14 includes a plurality of computers coupled in a network performing three basic functions. All of the computers 32, 34, 36, 38, 40, 42 are linked via a standard TCP/IP interface enabling physical placement of computers 32, 34, 36, 38, 40, 42 at remote connected locations as desired. In addition, the standard network interface among the computers allows for remote connectivity to the system 10 for debugging and monitoring.

A first class includes a main computer 32 having a CRT and keyboard as a user interface for operating the system 10. A second class includes a machine control computer 34 that provides control of the cutting section 12. A third class includes four packing computers 36, 38, 40, 42 that calculate potential packing solutions during the available time between scanning and cutting of the lumber. The computers 32, 34, 36, 38, 40, 42 of the computer section 14 are operably coupled with the scanning and cutting sections 12, 16 of the system 10 to enable command and control over the system 10.

The main computer 32 receives the images of the lumber generated by the cameras 30 and assembles a complete polygonal model of the lumber for analysis by the packing computers 36, 38, 40, 42. Each of the packing computers 36, 38, 40, 42 then run a selected packing algorithm in order to create a cutting solution for the lumber. The selected algorithms are assigned to each of the packing computers 36, 38, 40, 42 by the main computer and are designed to create one or more cutting solutions for the lumber based upon the various criteria including simplicity, minimized waste and maximized value.

Once the packing computers 36, 38, 40, 42 transfer the possible cutting solutions to the main computer 32, the main computer 32 selects the final cutting solution to be used by the system 10. Once packed, the main computer 32 calculates a cutting path for the board which minimizes the length of travel of laser assemblies 44 required to cut all parts from the board. The main computer 32 passes the cutting path calculated from the final cutting solution to the control computer 34, which in turn causes the cutting section 16 to carry out the solution by cutting the lumber in accordance with the solution.

The cutting section 16 includes a pair of opposed laser assemblies 44 mounted on either side of a laser carriage 46. The laser assemblies 44 each include a laser head 48 and are configured to direct a beam of collimated light of a predetermined energy on a target. The energy level of the laser may be adjusted to accommodate lumber of various thicknesses and densities, and the cutting speed. In addition, the laser beams are of such an energy level that they cut through only one half of the thickness of the lumber. The benefits of providing opposed laser assemblies 44 of variable energy are twofold. First, the beams, which are opposed, will not impinge upon each other, a situation that would damage the laser assemblies 44. Second, by providing two opposed laser assemblies 44, the blanks are cut from the lumber relatively quicker than if the system 10 utilized one laser assembly.

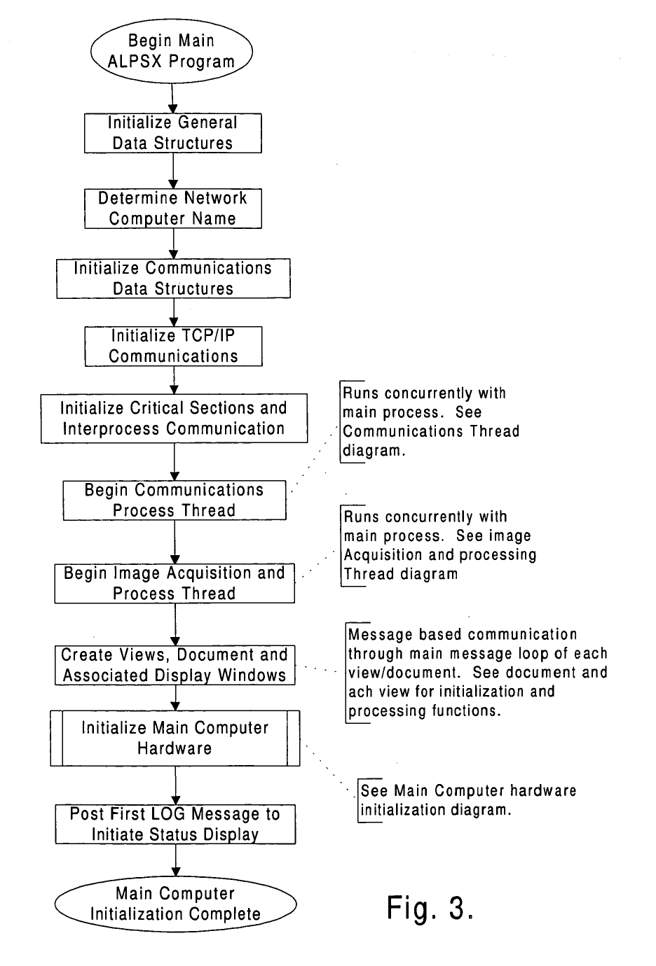

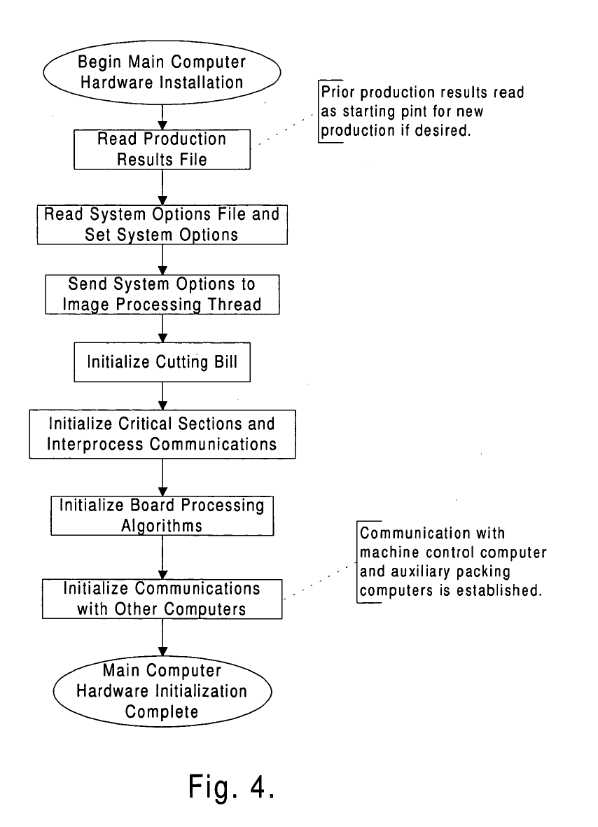

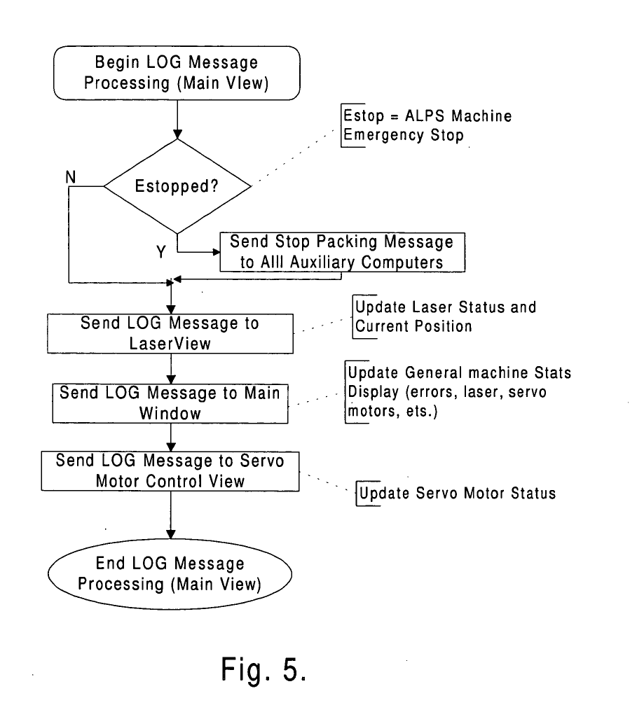

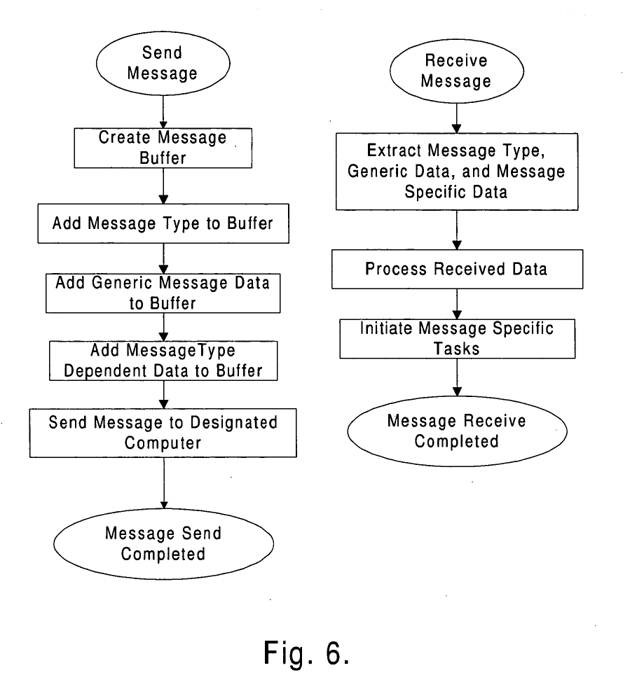

The overall operation of the system 10 is controlled by the ALPSX™ program. Prior to use of the system 10, the system is initialized as shown in FIGS. 3, 4, 5 and 6. In operation, an operator places a working piece of lumber on the infeed conveyor 18 and inspects the lumber one face at a time. Defects such as knots, pits or other undesirable portions are marked using a florescent marking crayon common in the wood working industry.

After each side is inspected and marked, the lumber is fed in a horizontal configuration using the infeed conveyor 18 into the system 10 until the lumber is positioned on the central conveyor 22 at the rotation station 20. The swing bars 24 rotate the lumber into the vertical configuration, locking pins 26 clamp the lumber in this configuration, and the swing bars 24 are retracted.

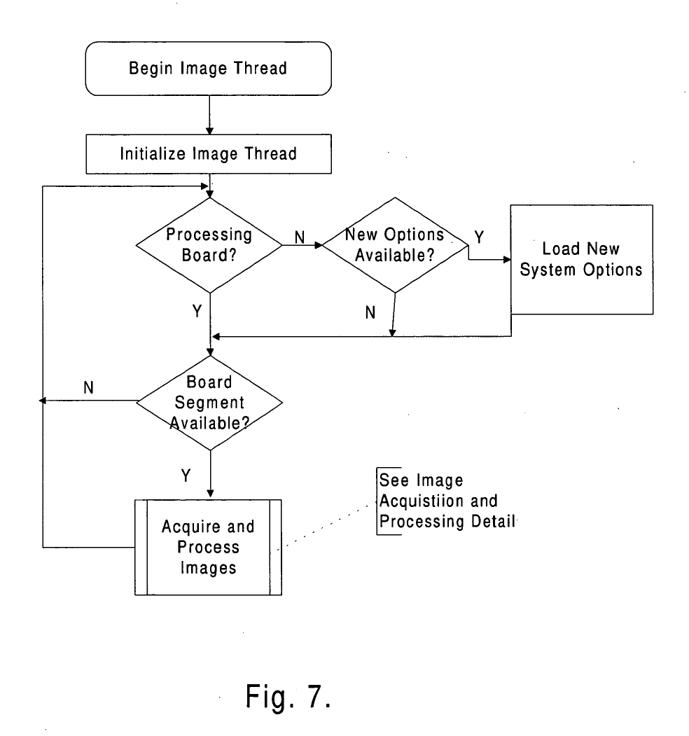

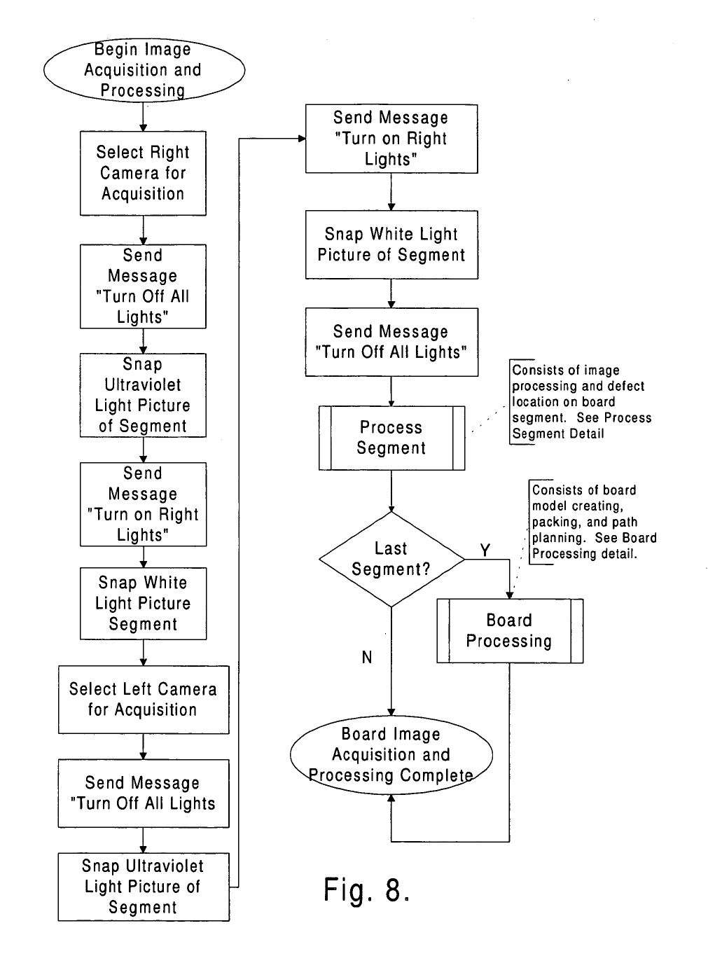

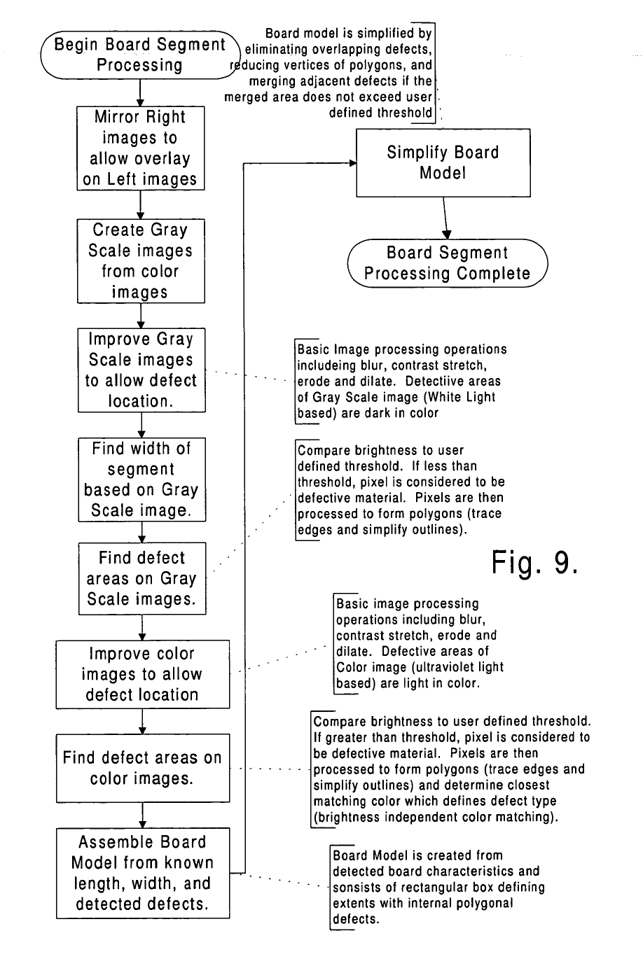

Referring now to FIG. 7, a series of images of each face of the lumber is captured by the cameras 30. A source of white light mounted and a source of black light are within the camera carriage 28 for illuminating the faces of the lumber along a section thereof. As the carriage 28 makes a first pass over the lumber in a first direction, the carriage will stop at a section of the lumber, the white light source will illuminate the faces of the lumber along the section and the cameras 30 will capture white light images of the lumber, and then the white light source will extinguish, the black light source will be activated to illuminate the faces of the lumber, and the cameras 30 will capture a black light image of the section of the lumber. This process is detailed in FIG. 8 and is repeated until the entire piece of lumber is scanned. The images are used by the main computer 32 to create a single, polygonal model of the lumber for processing by the packing computers 36, 38, 40, 42. The polygonal model of the lumber indicates defects in the lumber such as knots and pitting, and shows areas on the lumber that are less desirable for cutting blanks. The model is displayed on the CRT of the main computer 32. The creation of the polygonal model is shown in FIG. 9.

Once the camera carriage 28 has returned to its start position, the lumber is transferred by the central conveyor 22 from the scanning section 12 to the cutting section 16. After completion and assembly of the images and the creation of the polygonal model, the packing computers 36, 38, 40, 42 solve packing solutions based upon various packing algorithms. The main computer 32 reviews the white light image and scans for the edges of the lumber and defects in the lumber based generally upon the relative grayness of the lumber as compared with a standard for the particular type of wood being used. Pits and other defects generally show up as more gray or dark and are thus detected under white light. In addition to using white light, the black light images are used to depict defects noted manually by the operator and outlined with the florescent crayon. This information is combined to create the polygonal model.

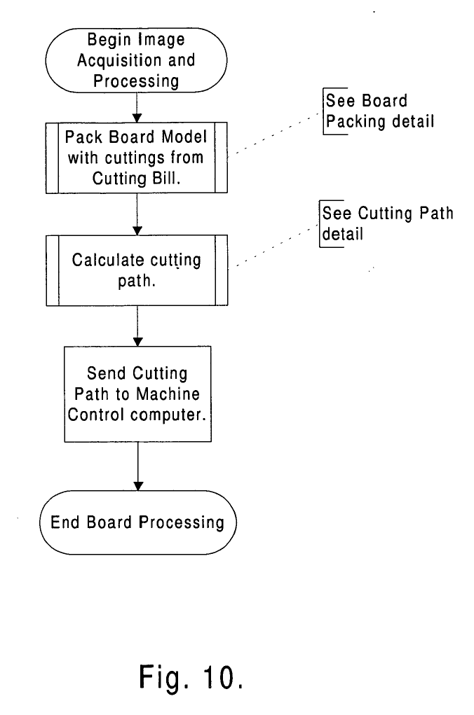

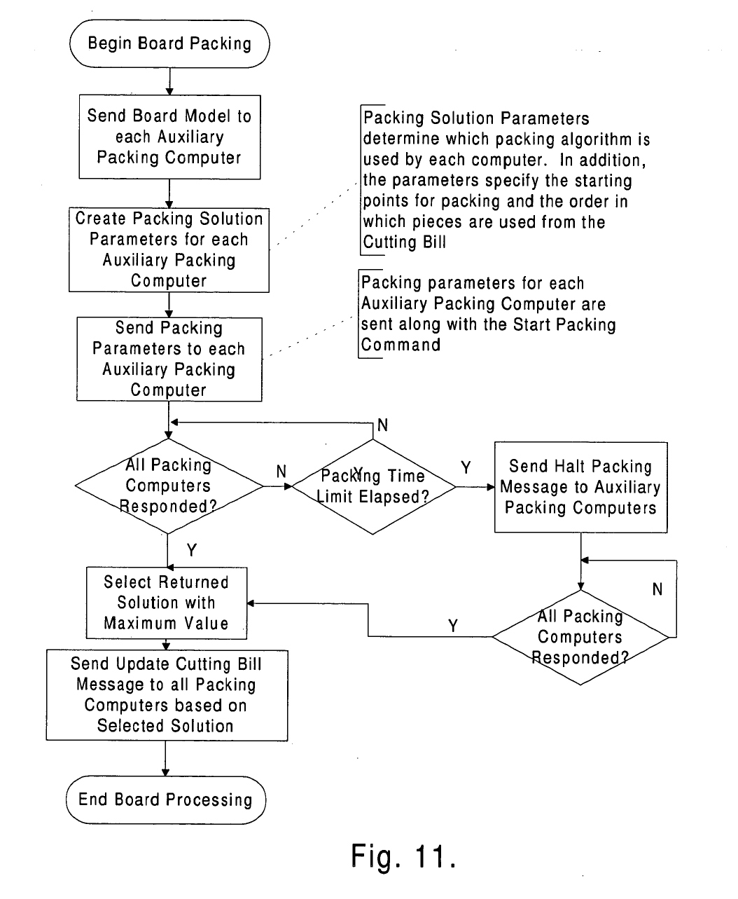

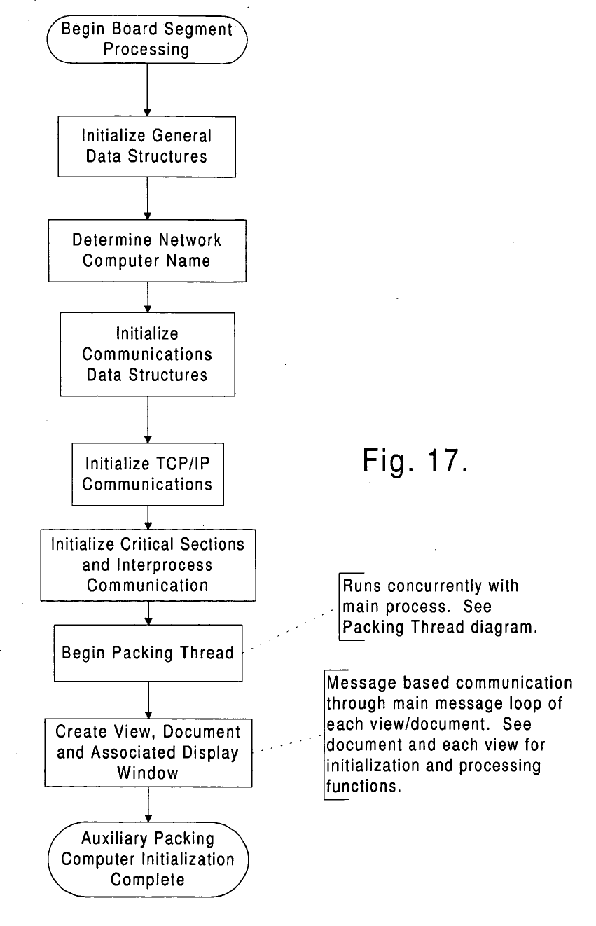

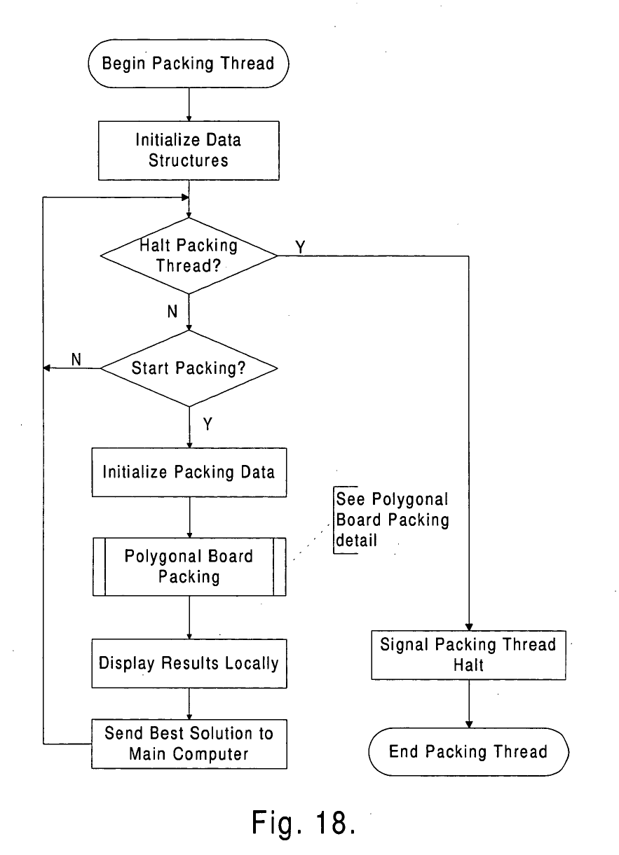

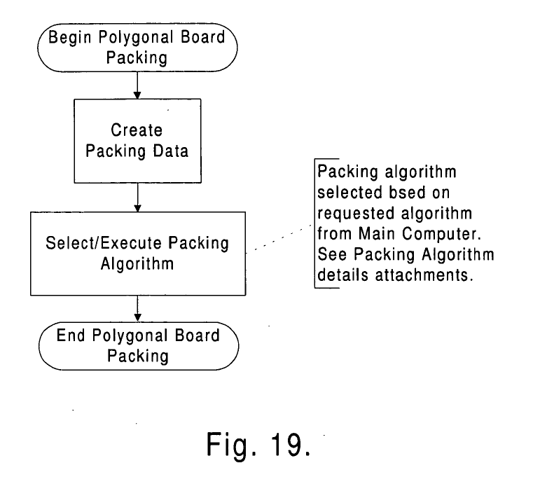

An overview of the packing and selection of the preferred cutting path is depicted in FIG. 10. As illustrated in FIG. 11, the polygonal model is sent to each of the packing computers 36, 38, 40, 42. In addition, the cutting bill (detailing the blanks that are to be cut from the board) is sent to the packing computers 36, 38, 40, 42. Each packing computer 36, 38, 40, 42 then solves for one or more packing solutions based upon the specific algorithm under which it is working. The initialization of the packing computers 36, 38, 40, 42 is shown in FIG. 17, while the packing thread and packing overview are depicted in FIGS. 18 and 19, respectively

The algorithms that are used by the packing computers are designated under the POLYPACK™ name. The first algorithm is designated POLYPACK3™ and is used by packing computer 36. This algorithm is designed to pack relatively quickly producing minimal complexity solutions rapidly. This algorithm is suitable even for large, complicated pieces of lumber. POLYPACK3™ tends to produce simple solutions with a single part and minimal orientation and rotation changes to parts. This algorithm operates quickly enough to test multiple packing scenarios even for the relatively complicated boards.

The next algorithm is known as POLYPACK4™ and is assigned to computer 38. This algorithm is similar to POLYPACK3™ except that it compacts parts or blanks more thoroughly after placement of each blank.

Packing computer 40 is assigned POLYPACK5™. This algorithm is designed to pack more slowly. It also more closely determines the impact of packing combinations of pieces from the cutting bill. POLYPACK5™ places as many blanks as possible before continuing to the next order in the cutting bill. This algorithm also tends to reorient pieces (horizontal and vertical mirroring) as packing to test potential nesting solutions.

The final algorithm, POLYPACK6™, is operated by packing computer 42. This algorithm is designed to pack more exhaustively than the other algorithms and may not produce a solution within production time constraints for larger or more complex boards. This algorithm resolves cutting bill priorities continually while packing to select the highest priority pieces. It also packs pieces to test nesting potential by continually mirroring pieces in both horizontal and vertical directions.

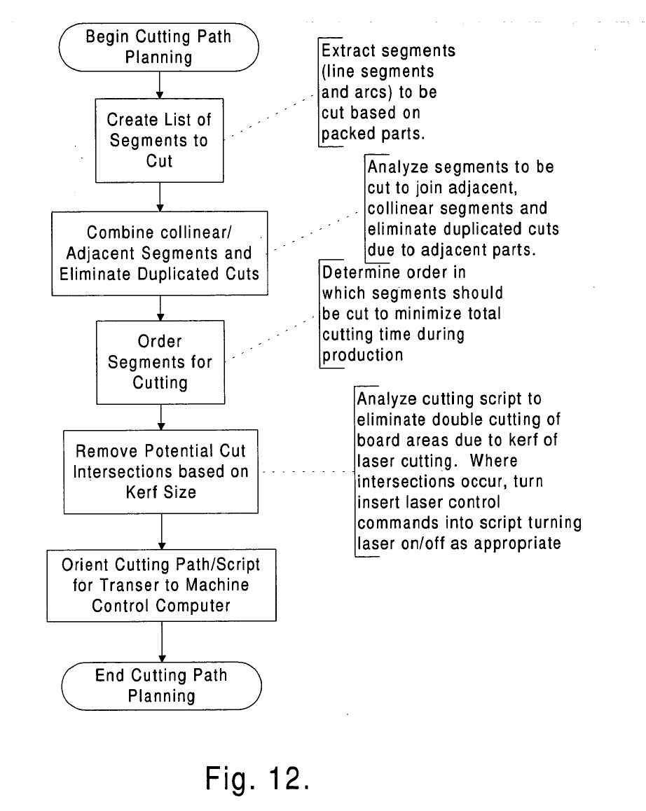

Once a predetermined time has elapsed, the lumber is moved and placed in the cutting section 16. The packing process is then closed and the solutions are sent to the main computer 32. The time is selected by the operator and is generally the amount of time between the end of the imaging process and the travel time required for placement of the lumber in the cutting section 16, and powering of the laser assemblies 44 for use. The main computer 32 assigns a value to each of the solutions derived by the packing computers 36, 38, 40, 42 and selects the solution with the highest value based upon the relative quality of the blanks, the number of the blanks and the amount of waste. The planning of the cutting path selected for the lumber is shown in FIG. 12.

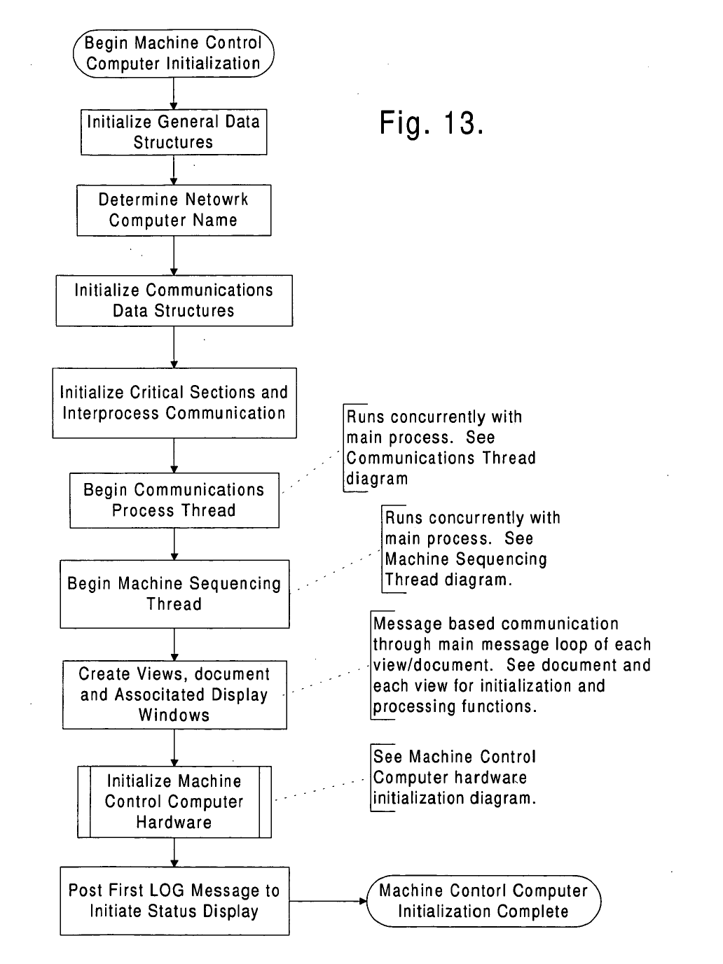

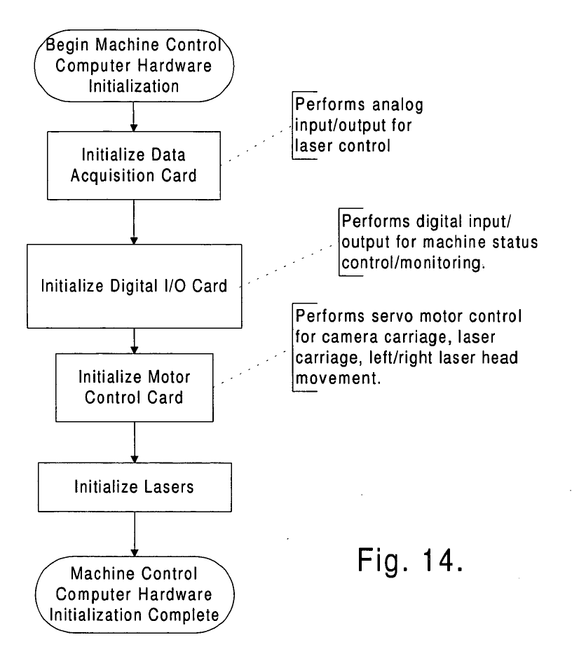

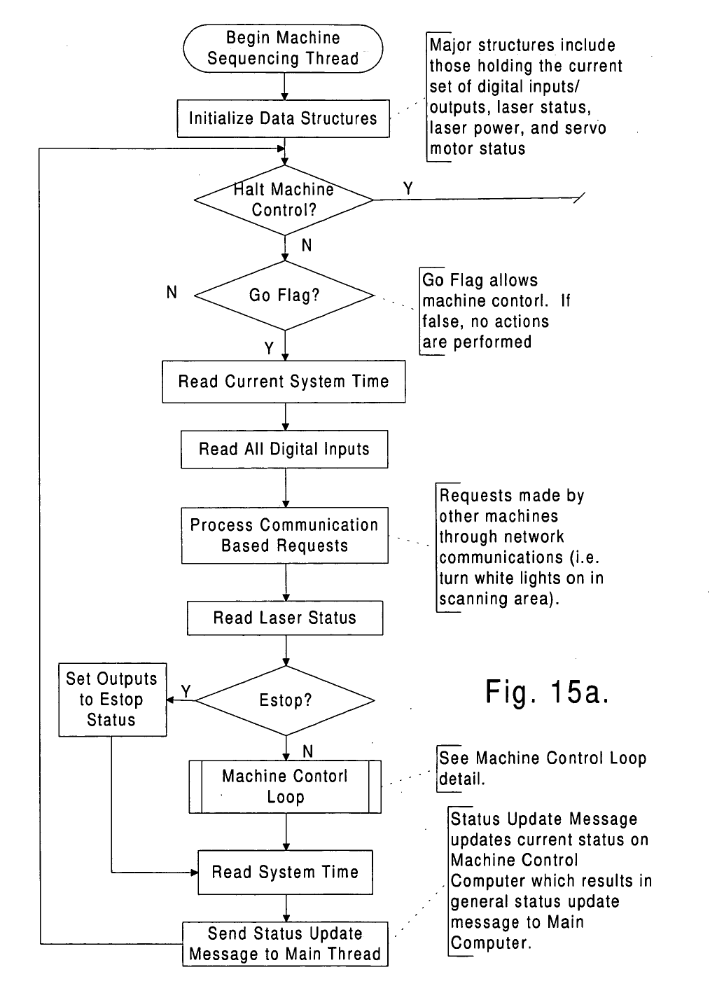

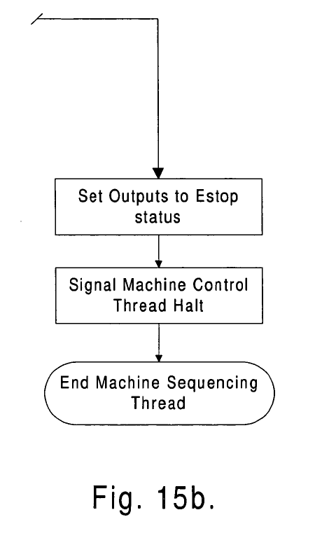

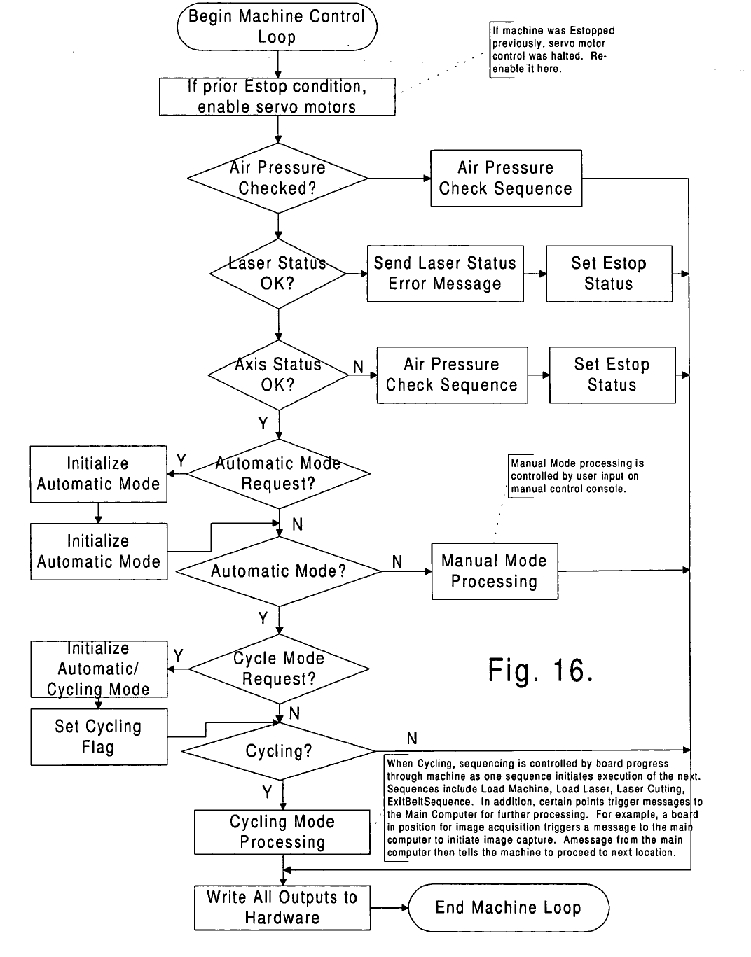

Once the cutting path has been selected by the main computer 32, the control computer 34 begins initialization of the cutting process. This initialization is depicted in FIGS. 13 and 14 and includes the steps of initializing the control computer hardware and the lasers 44. The machine sequencing thread and machine control loop are shown in FIGS. 15 and 16, respectively.

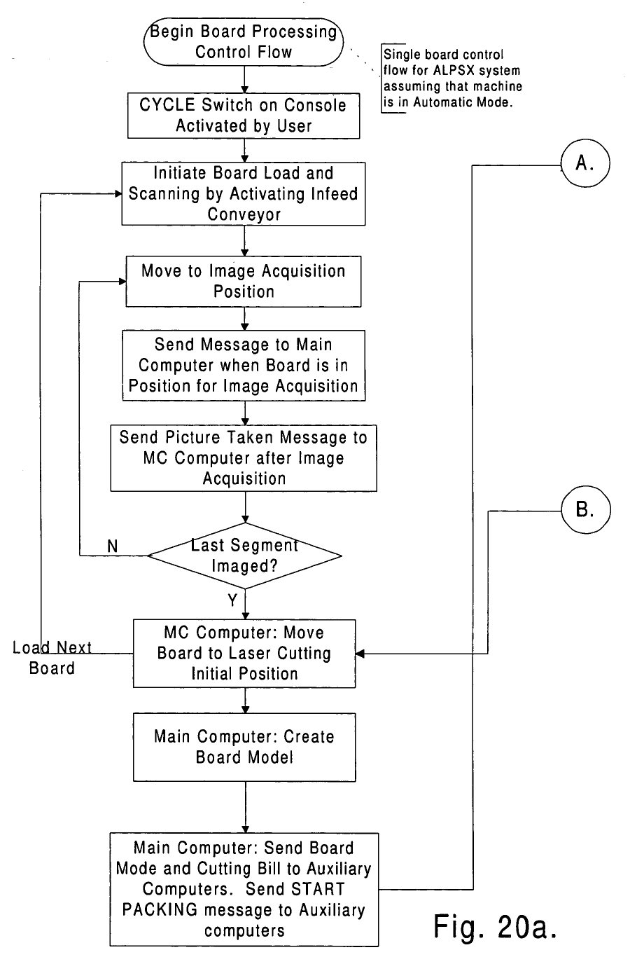

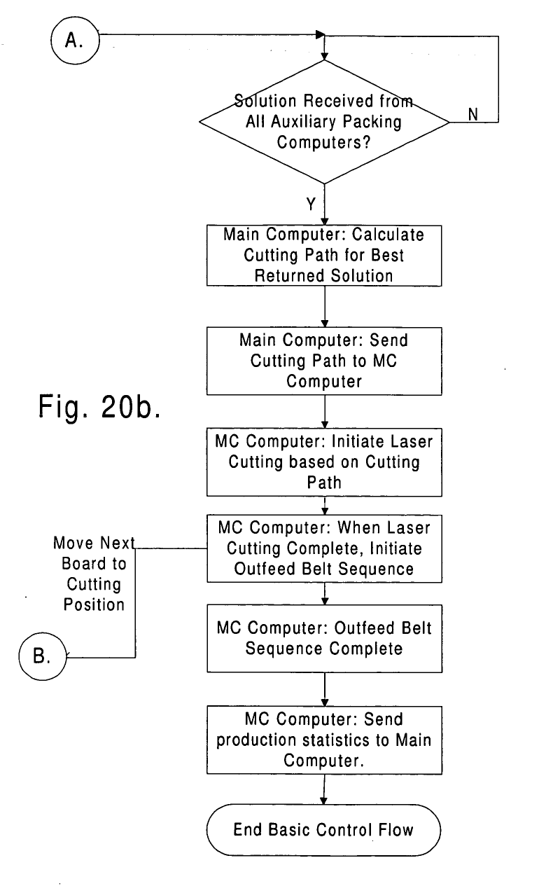

After the lumber has been cut by the lasers 44, the lumber is moved by the central conveyor 22 to an outfeed section 50. The operator then removes the cut lumber from the system and selectively knocks the blanks from the lumber with a soft mallet. It will be appreciated that the blanks may be removed at the site of the system 10 or be transported to a different location for removal. By using two lasers 44 that operate simultaneously providing a relatively precise and aligned, thin cuts, the blanks are retained in the lumber until selective removal. As a result, the cutting of the blanks may take place remotely from the blank removal process and the finishing process used to create a product from the blanks, such as gun stocks. FIG. 20 provides an overview of the operation of the system 10.

The present invention has been described with reference to the preferred embodiment of the lumber processing system 10. It is understood that changes may be made and equivalents employed without departing from the scope of the claims below.

1. A lumber processing system for cutting blanks from a piece of lumber comprising a scanning section, a computer section and a cutting section, the system further including:
a scanning assembly for collecting scanning data through scanning the lumber under white light and for scanning the lumber under ultraviolet light;
modeling means for creating a polygonal model of the lumber using the scanning data; and
packing means for using the model and for generating a packing solution of blanks to be cut from the lumber based upon the model.

2. The lumber processing system as set forth in claim 1, wherein the scanning assembly includes a pair of opposed cameras, a white light source and an ultraviolet light source.

3. The lumber processing system as set forth in claim 1, wherein the computer section includes a first, main computer for coordinating operation of the system as a modeling means, the main computer in communication with the scanning assembly for receiving the scanning data therefrom.

4. The lumber processing system as set forth in claim 3, wherein the packing means includes a plurality of packing computers networked and in communication with the main computer.

5. The lumber processing system as set forth in claim 3, wherein the cutting section includes a pair of opposed laser beam generating devices mounted within a laser carriage.

6. The lumber processing system as set forth in claim 5, wherein the laser beam generating devices are positioned in the carriage to direct the respective beams toward one another.
